(19) United States
(12) Patent Application Publication
(10) Pub. No.: US 2023/0076796 A1
(43) Pub. Date: Mar. 9, 2023

(54) THREE-DIMENSIONAL (3D) PRINTING

(71) Applicant: Hewlett-Packard Development Company, L.P., Spring, TX (US)

(72) Inventors: Kyle Wycoff, Palo Alto, CA (US); Emre Hiro Discekici, San Diego, CA (US); John Samuel Dilip Jangam, Palo Alto, CA (US); Thomas Craig Anthony, Palo Alto, CA (US)

(73) Assignee: Hewlett-Packard Development Company, L.P., Spring, TX (US)

(21) Appl. No.: 17/921,335

(22) PCT Filed: Apr. 29, 2020
(86) PCT No.: PCT/US2020/030387

§ 371 Date: Oct. 25, 2022

(51) Int. Cl. B22F 1/105; B33Y 10/00; B33Y 70/10; B22F 10/14; B22F 1/107

(52) U.S. Cl. CPC B22F 1/105; B33Y 10/00; B33Y 70/10; B22F 10/14; B22F 1/107; B22F 2301/10

(57) ABSTRACT

The present disclosure relates to a kit for 3D printing a 3D printed metal object. The kit comprises build material comprising metal particles; and a binding agent. The binding agent comprises a hydrated metal salt having a dehydration temperature of from 100 to about 250° C., and water. The binding agent may be either free from organic solvent and surfactant, or the binding agent comprises organic solvent and/or surfactant and the total amount of organic solvent and/or surfactant is less than 3 weight % based on the total weight of the binding agent.

### BACKGROUND

Three-dimensional (3D) printing may be an additive printing process used to make three-dimensional solid parts from a digital model. 3D printing can be often used in rapid product prototyping, mold generation, mold master generation, and short run manufacturing. Some 3D printing techniques can be considered additive processes because they involve the application of successive layers of material. This can be unlike machining processes, which often rely upon the removal of material to create the final part. 3D printing can often use curing or fusing of the building material, which for some materials may be accomplished using heat-assisted extrusion, melting, or sintering.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a simplified isometric view of an example 3D printing system disclosed herein; and

FIGS. 2A through 2F are schematic views depicting the formation of a patterned 3D printed metal object, a 3D printed metal object, and a 3D metallic part using examples of a 3D printing method disclosed herein.

### DETAILED DESCRIPTION

In a method of 3D printing a 3D printed metal object, a binding agent may be selectively applied to a layer of build material comprising metal particles. When the build material is subsequently heated, the selectively applied binding agent may bind the build material to form a layer of the 3D printed metal object. Further build material may be applied and the process repeated layer-by-layer until the 3D printed object is formed. The 3D printed object may then be removed from the 3D printer and sintered to form the final metal object. Unbound build material may be re-used in the 3D printing process.

It has been found that, in some instances, recycled build material can differ in properties from, for example, fresh build material e.g. from the same source. For example, in some instances, the ease with which the build material spreads to form a layer may be compromised. Furthermore, in some cases, the mechanical properties of the final sintered object may be compromised.

The present disclosure relates to a kit for 3D printing a 3D printed metal object. The kit comprises build material comprising metal particles; and a binding agent. The binding agent comprises a hydrated metal salt having a dehydration temperature of from 100 to about 250° C., and water. The binding agent may be either free from organic solvent and surfactant, or the binding agent comprises organic solvent and/or surfactant and the total amount of organic solvent and/or surfactant is less than 3 weight % based on the total weight of the binding agent.

The present disclosure also relates to a method of 3D printing a 3D printed metal object. The method comprises selectively applying a binding agent as described in the present disclosure onto build material comprising metal particles, and heating the build material and selectively applied binding agent to bind a layer of the 3D printed metal object. In some examples, the method also comprises (i) applying a layer of build material to a previously bound layer of the 3D printed object, (ii) selectively applying binding agent to the applied layer of build material, and (iii) heating the layer of build material to bind a further layer of the 3D printed metal object. Steps (i) to (iii) may be repeated, for example, in sequence a plurality of times. In some examples, the method can also comprise sintering bound layer(s) of the 3D printed metal object to form a sintered 3D printed metal object.

It has been found that, when binding agents comprising hydrated metal salts are employed, organic solvent and/or surfactant can be either omitted, or restricted to amounts of less than 3 weight % based on the total weight of the binding agent. The resulting binding agents can be used in 3D printing methods, in which build material comprising metal particles can be effectively recycled.

During printing, build material may be treated by selectively applying binding agent to the build material. When the build material is heated, liquid from the binding agent can evaporate, binding the treated build material to form a layer of the 3D printed metal object.

During evaporation, it has been found that some of the components in the liquid vehicle of the binding agent less volatile than water may come into contact and contaminate the untreated portions of the build material. In examples of the present disclosure, the risk of contaminating untreated portions of build material can be reduced as the concentration of organic compounds in the evaporated liquid is reduced or eliminated. This can reduce the risk of contaminating the untreated build material with excessive organic residue, promoting the build material's recyclability. The concentration of organic residue in the sintered 3D printed metal object can also be reduced. Furthermore, it has been found that the anti-kogation properties and/or jettability of the binding agent can be maintained despite the absence or low levels of organic solvent and/or surfactant. In addition, reducing or removing less volatile constituents from the binding agent facilitates evaporation of the ink vehicle, thereby reducing the energy and/or time needed to remove liquids from the binder.

In some examples, the binding agent may be free from organic compounds, or the binding agent may comprise organic compounds in an amount of less than 3 weight % based on the total weight of the binding agent.

In some examples, the binding agent may comprise organic solvent in an amount of less than about 1 weight % based on the total weight of the binding agent.

In some examples, the binding agent may comprise surfactant in an amount of less than about 0.5 weight % based on the total weight of the binding agent.

In some examples, the binding agent may comprise organic solvent and/or surfactant and the total amount of organic solvent and/or surfactant is less than about 1 weight % based on the total weight of the binding agent.

In some examples, the binding agent may consist essentially of hydrated metal salt and water.

In some examples, the amount of hydrated metal salt in the binding agent may be about 20 to about 65 weight % based on the total weight of the binding agent.

In some examples, a metal present in the build material may be the same as a metal present in the hydrated metal salt.

In some examples, the hydrated metal salt in the binding agent may comprise a metal cation selected from at least one of aluminium, magnesium, copper, zinc, iron, nickel, manganese, cobalt, molybdenum, chromium, tin and vanadium, and an anion selected from at least one of hydroxide, carbonate, sulphate, nitrate, acetate, formate, borate, chloride and bromide.

In some examples, the hydrated metal salt may comprise a metal cation selected from copper.

In some examples, the hydrated metal salt in the binding agent may be hydrated copper nitrate.

In some examples, the binding agent may comprise 35 to 58 weight % hydrated copper nitrate and 42 to 65 weight % water.

In some examples, the build material may comprise copper. For instance, the build material may comprise particles of copper metal or copper alloy.

### Build Material

The build material employed in the present disclosure comprises metal particles. The metal particles may comprise copper, for instance, in the form of copper metal or copper alloy. In some examples, the build material may comprise copper, for instance, copper metal or copper alloy.

The build material may be metallic. In some examples, the build material may comprise a single phase metallic material composed of one element. Alternatively, the build material may comprise two or more elements, which, for example, may be in the form of a single phase metallic alloy or a multiple phase metallic alloy. For some single phase metallic alloys, melting begins just above the solidus temperature (where melting is initiated) and is not complete until the liquidus temperature (temperature at which all the solid has melted) is exceeded. For other single phase metallic alloys, melting begins just above the peritectic temperature. The peritectic temperature is defined by the point where a single phase solid transforms into a two phase solid plus liquid mixture, where the solid above the peritectic temperature is of a different phase than the solid below the peritectic temperature. When the metallic build material is composed of two or more phases (e.g., a multiphase alloy made of two or more elements), melting generally begins when the eutectic or peritectic temperature is exceeded. The eutectic temperature is defined by the temperature at which a single phase liquid completely solidifies into a two phase solid. Generally, melting of the single phase metallic alloy or the multiple phase metallic alloy begins just above the solidus, eutectic, or peritectic temperature and is not complete until the liquidus temperature is exceeded. In some examples, sintering can occur below the solidus temperature, the peritectic temperature, or the eutectic temperature. In other examples, sintering occurs above the solidus temperature, the peritectic temperature, or the eutectic temperature. Sintering above the solidus temperature is known as super solidus sintering, and this technique may be useful when utilizing larger build material particles and/or to achieve high density. It is to be understood that the sintering temperature may be high enough to offer sufficient energy to allow atom mobility between adjacent particles.

Some examples of the build material include steels, stainless steel, bronzes, brasses, titanium (Ti) and alloys thereof, aluminum (Al) and alloys thereof, nickel (Ni) and alloys thereof, cobalt (Co) and alloys thereof, iron (Fe) and alloys thereof, gold (Au) and alloys thereof, silver (Ag) and alloys thereof, platinum (Pt) and alloys thereof, and copper (Cu) and alloys thereof. Some specific examples include AlSM OMg, 2xxx series aluminum, 4xxx series aluminum, CoCr MPI, CoCr SP2, MaragingSteel MS1, Hastelloy C, Hastelloy X, NickelAlloy HX, Inconel IN625, Inconel IN718, SS GP1, SS 17-4PH, SS 316L, Ti6Al4V, and Ti-6Al-4V EL7. While several example alloys have been described, it is to be understood that other alloy build materials may be used, such as refractory metals.

In some examples, the build material comprises copper particles. By “copper particles”, it is meant particles comprising copper metal or copper alloy. Examples of copper alloys include copper-tin (bronze), copper-zinc (brass) and copper-nickel (Monel) alloys. Copper may also be present in the copper particles as a minor constituent of the alloy. For example, the copper-containing alloy may be a copper-containing steel or an aluminium alloy that comprises copper. For instance, 17-4PH steel has 3-5 wt % Cu and Cu content in 2xxx aluminum ranges from 2-6 wt %.

Where the build material comprises a copper alloy, the amount of copper may be at least about 1 weight %, at least about 2 weight %, at least about 3 weight % of the weight of the alloy. In some examples, the amount of copper may be up to 100% by weight of the total weight of the alloy, for example, up to about 99 weight %, up to about 98 weight %, up to about 95 weight % of the total weight of the alloy.

The build material may be made up of similarly sized particles or differently sized particles. In some examples, the build material has an average particle size of from about 5 to about 20 microns.

The term “size”, as used herein with regard to the build material, refers to the diameter of a particle, for example, a substantially spherical particle (i.e., a spherical or near-spherical particle having a sphericity of >0.84), or the average diameter of a non-spherical particle (i.e., the average of multiple diameters across the particle).

In some examples, particles of a particle size of from about 5 microns to about 20 microns have good flowability and can be spread relatively easily. As an example, the average particle size of the particles of the build material may range from about 1 microns to about 200 microns. As another example, the average size of the particles of the build material ranges from about 10 microns to about 100 microns. As another example, the average size of the particles of the build material ranges from about 2 microns to about 20 microns. As still another example, the average size of the particles of the metallic build material ranges from 15 microns to about 50 microns.

### Binding Agent

As mentioned above, the binding agent comprises a hydrated metal salt having a dehydration temperature of from 100 to about 250° C., and water. In some examples, dehydration temperature as used in this disclosure may be the temperature by which all, or nearly all, of the water molecules in the hydrated metal salt have either been removed by evaporation or reacted to form other compounds. Dehydration may be progressive. Dehydration may occur in multiple discrete steps as the hydrated metal salt is heated. The binding agent may be either free from organic solvent and surfactant, or the binding agent comprises organic solvent and/or surfactant and the total amount of organic solvent and/or surfactant is less than 3 weight % based on the total weight of the binding agent.

In some examples, the dehydration temperature may be more than about 100° C., or more than about 110° C., or more than about 120° C., or more than about 130° C., or more than about 140° C., or more than about 150° C., or more than about 160° C., or more than about 170° C., or more than about 180° C., or more than about 190° C., or more than about 200° C., or more than about 210° C., or more than about 220° C., or more than about 230° C., or more than about 240° C., or less than about 250° C., or less than about 240° C.

In some examples, the dehydration temperature may be less than about 230° C., or less than about 220° C., or less than about 210° C., or less than about 200° C., or less than about 190° C., or less than about 180° C., less than about 170° C., or less than about 160° C., or less than about 150° C., or less than about 140° C., or less than about 130° C., or less than about 120° C., or less than about 110° C.

In some examples, the dehydration temperature may be from about 100° C. to about 240° C., or from about 100° C. to about 230° C., or from about 100° C. to about 220° C., or from about 100° C. to about 210° C., or from about 100° C. to about 200° C., or from about 100° C. to about 190° C., or from about 100° C. to about 180° C., or from about 100° C. to about 170° C., or from about 100° C. to about 160° C., or from about 100° C. to about 150° C., or from about 100° C. to about 140° C., or from about 100° C. to about 130° C., or from about 100° C. to about 120° C., or from about 100° C. to about 110° C.

In some examples, the hydrated metal salt comprises at least one metal cation selected from the group consisting of aluminum, magnesium, copper, zinc, iron, nickel, manganese, cobalt, molybdenum, chromium, tin, vanadium, and combinations thereof. The hydrated metal salt may comprise at least one anion selected from the group consisting of hydroxide, carbonate, sulfate, nitrate, acetate, formate, borate, chloride, bromide, and combinations thereof.

In some examples, the hydrated metal salt may comprise copper cations.

In some examples, the hydrated metal salt may comprise nitrate anions.

In some examples, the hydrated metal salt may be selected from the group consisting of hydrated copper nitrate, hydrated iron nitrate, hydrated nickel nitrate, hydrated manganese nitrate, hydrated cobalt nitrate, hydrated iron acetate, and combinations thereof.

In some examples, the hydrated metal salt may be hydrated copper nitrate. For instance, the hydrated metal salt may be hydrated copper (II) nitrate. In some examples, the hydrated metal salt may be copper (11) nitrate trihydrate.

In some examples, the build material may comprise a metal (e.g. at least one metal) that is the same as the metal cation in the hydrated metal salt. For example, the build material may comprise copper particles (e.g. copper metal or copper alloy particles) and the metal cation may be copper (e.g. copper (II)).

In some examples, the hydrated metal salt may be present in the binding agent in an amount below the saturation limit of the hydrated metal salt at 25 degrees C.

In some examples, the hydrated metal salt may be present in the binding agent at about 10 weight % to up to 100 weight % of the saturation concentration of the hydrated metal salt in water at 25 degrees C. For example, the hydrated metal salt may be present in the binding agent at about 30 weight % to up to 99 weight % of the saturation concentration, for example, at about 25 weight % up to 95 weight % of the saturation concentration. In some examples, the hydrated metal salt may be present in the binding agent in an amount less than 95% of the saturation limit of the hydrated metal salt at 25 degrees C.

In some examples, the hydrated metal salt may be present in an amount of at least about 5 weight % of the total weight of the binding agent, for example, at least about 10 weight %, at least about 15 weight %, at least about 20 weight %, at least about 25 weight %, at least about 30 weight %, at least about 35 weight % or at least about 40 weight %.

In some examples, the hydrated metal salt may be present in an amount of at most about 70 weight % of the total weight of the binding agent, for example, at most about 65 weight % or at most about 60 weight %.

In some examples, the hydrated metal salt may be present in an amount of from about 5 wt % to about 70 wt % based on the total weight of the binding agent, or from about 10 wt % to about 65 wt % based on the total weight of the binding agent, or from about 15 wt % to about 60 wt % based on the total weight of the binding agent, or from about 20 wt % to about 55 wt % based on the total weight of the binding agent, or from about 25 wt % to about 55 wt % based on the total weight of the binding agent, or from about 30 wt % to about 50 wt % based on the total weight of the binding agent, or from about 35 wt % to about 50 wt % based on the total weight of the binding agent, or from about 40 wt % to about 50 wt % based on the total weight of the binding agent, or from about 45 wt % to about 50 wt % based on the total weight of the binding agent.

In some examples, the hydrated metal salt may be hydrated copper nitrate (e.g. hydrated copper (II) nitrate or copper (II) nitrate trihydrate). The amount of hydrated copper nitrate in the binding agent may be at least about 30 weight %, for example, at least about 40 weight % or at least 45 weight %. The amount of hydrated copper nitrate in the binding agent may be at most about 58 weight %, for example, at most about 56 weight %. In some examples, the amount of hydrated copper nitrate may be from about 35 to about 58 weight %, for instance, from about 40 to about 58 weight %.

As mentioned above, the binding agent also comprises water. Water may be the liquid vehicle of the binding agent. Water may be present in an amount of at least about 40 weight %, for example, at least about 42 weight %, at least about 45 weight %, at least about 50 weight % or at least about 55 weight %.

In some examples, water may be present in an amount of about 40 to about 70 weight %, for instance, about 42 to about 67 weight %, about 45 to about 65 weight %, about 50 to about 65 weight % or about 55 to about 60 weight %.

In some examples, the binding agent consists essentially of water and hydrated metal salt. The hydrated metal salt may be completely dissolved in water. For example, the binding agent may consist essentially of water and a hydrated copper salt, for instance, hydrated copper nitrate (e.g. copper (II) nitrate trihydrate).

The binding agent may consist essentially of about 30 to 60 weight % hydrated copper nitrate and 40 to 70 weight % water. In one example, the binding agent may consist essentially of about 40 to about 58 weight % hydrated copper nitrate and from about 42 to about 60 weight % water.

The binding agent may be free from organic solvent and/or surfactant. Alternatively, the binding agent may comprise organic solvent and/or surfactant but the total amount of organic solvent and/or surfactant may be less than 3 weight % based on the total weight of the binding agent. The total amount of organic solvent and/or surfactant may be less than 2 weight %, for instance, less than 1 weight % or less than 0.8 weight % based on the total weight of the binding agent. The total amount of organic solvent and/or surfactant may be less than 0.6 weight %, for instance, less than 0.5 weight % or less than 0.4 weight % based on the total weight of the binding agent.

Organic solvents that may be present include aliphatic alcohols, aromatic alcohols, diols, glycol ethers, polyglycol ethers, 2-pyrrolidones, caprolactams, formamides, acetamides, glycols, and long chain alcohols. Specific examples include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C6-C12) of polyethylene glycol alkyl ethers, N-alkyl caprolactams, unsubstituted caprolactams, both substituted and unsubstituted formamides, and both substituted and unsubstituted acetamides.

Other organic solvents include water-soluble high-boiling point solvents (i.e., humectants), which have a boiling point of at least 120° C., or higher. Some examples of such high-boiling point solvents include 2-pyrrolidone (boiling point of about 245° C.), 2-methyl-1,3-propanediol (boiling point of about 212° C.), and combinations thereof.

Where an organic solvent is present, the organic solvent may be present in an amount of less than about 3 weight %, for example, less than about 2 weight % or less than about 1 weight %. In some examples, the organic solvent may be present in an amount of less than about 0.5 weight %. In some examples, the total amount of organic solvent may be less than about 3 weight %, for example, less than about 2 weight %, less than about 1 weight %, less than 0.5 weight %, less than 0.2 weight, or less than 0.1 weight %.

In some examples, the binding agent is substantially free from 2-pyrrolidone. Alternatively, 2-pyrrolidone may be present but in an amount of less than about 3 weight %, for example, less than about 2 weight %, less than about 1 weight %, less than 0.5 weight %, less than 0.2 weight, or less than 0.1 weight %.

Where present, suitable surfactants include non-ionic surfactants. Examples of suitable surfactants include surfactants based on acetylenic diol chemistry (e.g., SURFYNOL® SEF from Air Products and Chemicals, Inc.), fluorosurfactants (e.g., CAPSTONE® fluorosurfactants from DuPont, previously known as ZONYL FSO), and combinations thereof. In other examples, the surfactant may be an ethoxylated low-foam wetting agent (e.g., SURFYNOL® 440 or SURFYNOL® CT-111 from Air Products and Chemical Inc.) or an ethoxylated wetting agent and molecular defoamer (e.g., SURFYNOL® 420 from Air Products and Chemical Inc.). Still other suitable surfactants include non-ionic wetting agents and molecular defoamers (e.g., SURFYNOL® 104E from Air Products and Chemical Inc.) or water-soluble, non-ionic surfactants (e.g., TERGITOL™ TMN-6 or TERGITOL™ 15-S-7 from The Dow Chemical Company). In other examples, the surfactant may be a sulfonated surfactant, for example, a disulfonated surfactant, such as an alkyldiphenyloxide disulfonate (e.g. DOWFAX™ 2A1). In some examples, it may be useful to utilize a surfactant having a hydrophilic-lipophilic balance (HLB) less than 10.

When a surfactant is used, the total amount of surfactant(s) in the binding agent may range from about 0 to about 3 weight % based on the total weight of the binding agent. The total amount of surfactant(s) in the binding agent may be less than about 3 weight %, for example, less than about 2 weight %, less than about 1 weight %, less than about 0.5 weight %, less than about 0.2 weight % or less than 0.1 weight % based on the total weight of the binding agent.

In some examples, the binding agent may be free from fluorosurfactants. Alternatively, the binding agent may contain fluorosurfactant in an amount of less than about 1 weight %, for example, less than about 0.5 weight %, less than about 0.1 weight %, less than about 0.08 weight %, less than about 0.06 weight %, less than about 0.04 weight %, less than about 0.02 weight % or less than about 0.01 weight %.

In some examples, the binding agent may be free from sulfonated surfactants. Alternatively, the binding agent may contain sulfonated surfactant in an amount of less than about 1 weight %, for example, less than about 0.5 weight %, less than about 0.3 weight %, less than about 0.1 weight % or less than 0.05 weight %.

In some examples, the binding agent may be free from sulfonated surfactants and fluorinated surfactants. Alternatively, the total amount of sulfonated surfactant and fluorinated surfactant may be less than about 1 weight %, for example, less than about 0.5 weight %, less than about 0.3 weight %, less than about 0.1 weight % or less than 0.05 weight %.

In some examples, the binding agent may be free from organic compounds, or the binding agent may comprise organic compounds in an amount of less than 3 weight % based on the total weight of the binding agent.

Where the binding agent may comprise organic compounds, such organic compounds may be present in an amount of less than about 2 weight %, for example, less than about 1.5 weight % or less than about 1 weight % based on the total weight of the binding agent. In some examples, the total amount of organic compounds may be less than about 0.8 weight %, less than about 0.5 weight %, less than about 0.3 weight %, less than about 0.2 weight %, less than about 0.1 weight % or less than about 0.05 weight %.

Where organic compounds are present, the organic compounds may be organic solvent and/or surfactant. Examples of organic solvent and/or surfactant that may be present are described above. Examples of other organic compounds include antimicrobial agent(s), anti-kogation agent(s), viscosity modifier(s), pH adjuster(s) and/or sequestering agent(s).

Suitable antimicrobial agents include biocides and fungicides. Example antimicrobial agents may include the NUOSEPT™ (Troy Corp.), UCARCIDE™ (Dow Chemical Co.), ACTICIDE® M20 (Thor), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., Bardac® 2250 and 2280, Barquat® 50-65B, and Carboquat® 250-T, all from Lonza Ltd. Corp.), and an aqueous solution of methylisothiazolone (e.g., Kordek® MLX from Dow Chemical Co.). The biocide or antimicrobial may be added in any amount ranging from about 0.05 wt % to about 0.5 wt % (as indicated by regulatory usage levels) with respect to the total weight of the binding agent.

In some examples, the biocide and/or antimicrobial component may be present in an amount of less than 0.1 weight %, for example, less than about 0.08 weight %, or less than 0.005 weight %. In some examples, the binding agent is devoid of biocide and/or antimicrobial agent.

As mentioned above, an anti-kogation agent may be included in the binding agent. Kogation refers to the deposit of dried ink (e.g., binding agent) on a heating element of a thermal inkjet printhead. Anti-kogation agent(s) is/are included to assist in preventing the buildup of kogation. Examples of suitable anti-kogation agents include oleth-3-phosphate (e.g., commercially available as CRODAFOS™ O3A or CRODAFOS™ N-3 acid from Croda), or a combination of oleth-3-phosphate and a low molecular weight (e.g., <5,000) polyacrylic acid polymer (e.g., commercially available as CARBOSPERSE™ K-7028 Polyacrylate from Lubrizol). Whether a single anti-kogation agent is used or a combination of anti-kogation agents is used, the total amount of anti-kogation agent(s) in the binding agent may range from greater than 0.2 wt % to about 0.8 wt % based on the total weight of the binding agent. In an example, the oleth-3-phosphate is included in an amount ranging from about 0.2 wt % to about 0.6 wt %, and the low molecular weight polyacrylic acid polymer is included in an amount ranging from about 0.005 wt % to about 0.03 wt %.

In some examples, the anti-kogation agent may be present in an amount of less than 0.2 weight %, for example, less than about 0.1 weight %, or less than 0.05 weight %. In some examples, the binding agent may be devoid of anti-kogation agent.

Sequestering agents, such as EDTA (ethylene diamine tetra acetic acid), may be included to eliminate the deleterious effects of heavy metal impurities, and buffer solutions may be used to control the pH of the binding agent. From 0.01 wt % to 2 wt % of each of these components, for example, can be used.

In some examples, the sequestering agent may be present in an amount of less than 2 weight %, for example, less than about 0.2 weight %, or less than 0.1 weight %. In some examples, the binding agent may be devoid of sequestering agent.

As mentioned above, in some examples, the binding agent may be free from organic compounds, or the binding agent may comprise organic compounds in an amount of less than 3 weight % based on the total weight of the binding agent. In some examples, the binding agent may be free from organic compounds, or comprise less than about 2.5 weight %, for example, less than about 2.0 weight %, less than about 1.5 weight %, less than about 1.0 weight %, less than about 0.8 weight %, less than about 0.6 weight %, less than about 0.5 weight %, less than about 0.2 weight % organic compounds.

### 3D Printing

In 3D printing, a layer of build material may be applied to a print platform. A binding agent may then be selectively jetted onto at least a portion of the layer of build material. A further layer of build material may then be applied, and a binding agent may then be selectively jetted onto a portion of the newly applied layer. The process may be repeated one or more times.

By selectively applying (e.g. by jetting) the binding agent onto the build material, the build material becomes patterned. The binding agent may be applied (e.g. jetted) by thermal inkjet or piezoelectric inkjet. The patterned build material may then be bound to form a layer. Binding may be carried out e.g. by applying heat to the patterned build material. For example, heating may cause at least some of the liquid in the binding agent to evaporate. This evaporation may result in some densification, for example, through capillary action of the layer. Alternatively or additionally, heating may cause physical and/or chemical changes in the binder that cause the build material to be stabilised.

Binding may be performed after a single pass of the binding agent or after a few passes of binding agent have been applied. Alternatively or additionally, binding may be performed to a patterned 3D printed object to affect the binding of multiple layers.

The procedure used to bind the build material may depend, for example, the nature of the build material and the binding agent. In some examples, binding may be performed by heating to a binding temperature of, for instance, about 80 to about 300 degrees C. Binding together of the printed build material particles can be accomplished by heating the printed layer to evaporate liquids in the binding agent and partially dehydrate the hydrated metal salt. In a 3D printing system thermal energy can be supplied from overhead energy sources or from energy sources that heat the build bed from the sides or bottom. Overhead energy sources can heat the surface of the powder in a pulsed fashion, consistent with layer-by-layer processing, whereas build bed heaters can heat the entire build bed volume and are suited for maintaining the temperature of the build bed at a desired value. Both types of heaters (overhead or build bed) may be employed to establish the binding temperature needed to create the printed metal object.

In some examples, the binding temperature may be from about 100° C. to about 280° C., or from about 100° C. to about 250° C., or from about 100° C. to about 240° C., or from about 100° C. to about 230°. In some examples, the binding temperature may be from about 130° C. to about 280° C., or from about 140° C. to about 250° C., or from about 150° C. to about 240° C., or from about 160° C. to about 230° C.

Where the build material comprises copper and/or the binding agent comprises a hydrated copper salt (e.g. hydrated copper nitrate), the binding temperature may be from about 110° C. to about 180° C.

In some examples, after binding, the build material (e.g. patterned with the binding agent) may be sintered. Sintering temperatures may be dependent on the metal alloy being printed and typically range from about 70% to 97% of the metal alloy melting point measured in degrees Kelvin. For example, suitable sintering temperatures for aluminum and aluminum alloys are from about 400° C. to about 630° C., for copper and copper alloys are from about 700° C. to about 1050° C., and for iron and iron alloys are from about 950° C. to about 1450° C. Suitable sintering temperature ranges are from about 500° C. to about 1500° C., or from about 600° C. to about 1500° C., or from about 700° C. to about 150° C., or from about 800° C. to about 1500° C., or from about 900° C. to about 1500° C., or from about 1000° C. to about 1500° C., or from about 1 100° C. to about 1500° C., or from about 1200° C. to about 1500° C., or from about 1300° C. to about 1500° C., or from about 1400° C. to about 1500° C.

Where the build material comprises copper and/or the binding agent comprises a hydrated copper salt (e.g. hydrated copper nitrate), the sintering temperature may be from about 700° C. to about 1050° C.

In some examples, the heating of the three-dimensional object to the sintering temperature is performed for a sintering time period ranging from about 10 minutes to about 20 hours, or at least 10 minutes, or at least 1 hour, or at least 2 hours, or at least 4 hours, or at least 10 hours, or at least 20 hours.

Sintering may be performed in a reducing atmosphere, for example, in the presence of hydrogen. In some examples, sintering may be performed in the presence of hydrogen and an inert gas, for example, argon or under vacuum.

When the binder is heated during printing of the 3D printed metal object, at least partial decomposition of the binder can occur. This decomposition may facilitate consolidation of the build material to form the 3D printed object. For example, the hydrated metal salt can be at least partially dehydrated. In some cases, the hydrated metal salt can be partially hydrolyzed in addition to being partially dehydrated. In some cases, the hydrated metal salt can be partially dehydrated, partially hydrolyzed, and the anion can be partially decomposed. In some instances, the hydrated metal salt can be partially decomposed to a metal oxide.

In some instances, the hydrated metal salt can decompose completely to a metal oxide and subsequently be reduced to a metal. This stage-wise decomposition may occur on exposure to elevated temperatures, for example, during binding and/or sintering.

In some examples, the 3D printed metal object e.g. prior to sintering may have a fracture strength as measured in a 3-point bend test of from about 2 MPa to about 20 MPa, or from about 3 MPa to about 20 MPa. The flexural strength may allow the object to be e.g. handled or transferred from the 3D printer for sintering, for example, in an oven.

In some examples, the 3D printed metal object comprises the dehydrated metal salt and other decomposition products of the metal salt, for example, the corresponding metal oxide.

In some examples, the dehydrated metal salt is present in the 3D printed metal object in an amount of from about 0.2 wt % to about 20 wt % based on the total weight of the 3D printed metal object, or from about 0.2 wt % to about 15 wt % based on the total weight of the 3D printed metal object, or from about 0.2 wt % to about 10 wt % based on the total weight of the 3D printed metal object, or from about 0.2 wt % to about 5 wt % based on the total weight of the 3D printed metal object, or from about 0.2 wt % to about 1 wt % based on the total weight of the 3D printed metal object, or less than about 20 wt % based on the total weight of the 3D printed metal object, or less than about 15 wt % based on the total weight of the 3D printed metal object, or less than about 10 wt % based on the total weight of the 3D printed metal object, or less than about 5 wt % based on the total weight of the 3D printed metal object, or less than about 1 wt % based on the total weight of the 3D printed metal object, or less than about 0.5 wt % based on the total weight of the 3D printed metal object, or less than about 0.02 wt % based on the total weight of the 3D printed metal object, or about 0 wt % based on the total weight of the 3D printed metal object.

In some examples, the corresponding metal oxide is present in the 3D printed metal object in an amount of from about 0 wt % to about 10 wt % based on the total weight of the 3D printed metal object, or from about 0 wt % to about 5 wt % based on the total weight of the 3D printed metal object, or from about 0 wt % to about 1 wt % based on the total weight of the 3D printed metal object, or less than about 10 wt % based on the total weight of the 3D printed metal object, or less than about 5 wt % based on the total weight of the 3D printed metal object, or less than about 1 wt % based on the total weight of the 3D printed metal object, or less than about 0.1 wt % based on the total weight of the 3D printed metal object, or about 0 wt % based on the total weight of the 3D printed metal object.

In some examples, the 3D printed metal object is substantially free from the hydrated metal salt.

### FIGURES

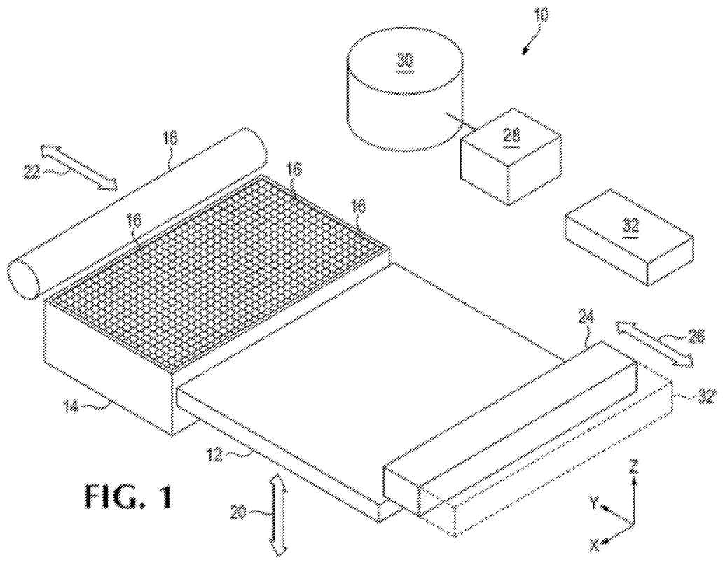

Referring now to FIG. 1, an example of a 3D printing system 10 is depicted. It is to be understood that the 3D printing system 10 may include additional components and that some of the components described with reference to the Figures may be removed and/or modified. Furthermore, components of the 3D printing system 10 depicted in FIG. 1 may not be drawn to scale and thus, the 3D printing system 10 may have a different size and/or configuration other than as shown therein.

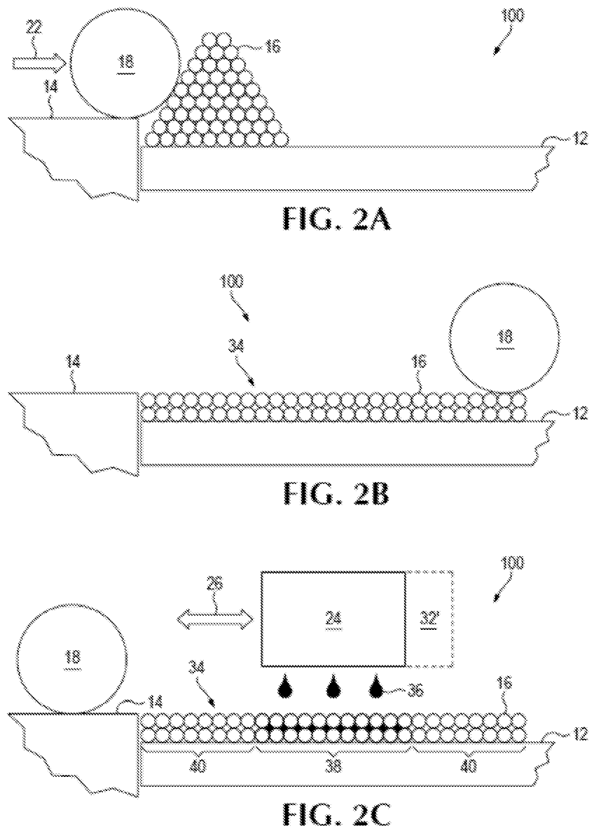

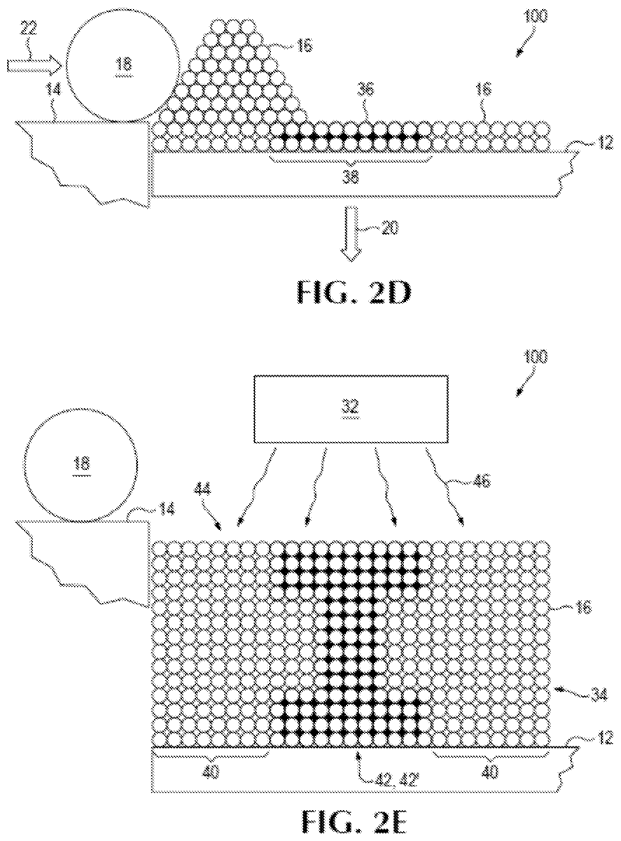

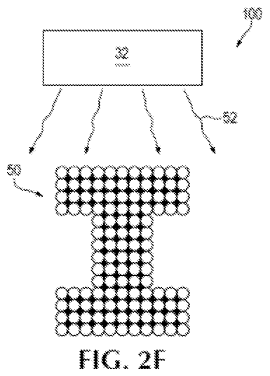

The three-dimensional (3D) printing system 10 generally includes a supply 14 of build material 16; a build material distributor 18; a supply of a binding agent 36, the binding agent 36 including a liquid vehicle and hydrated metal salt dispersed in the liquid vehicle (e.g. water); an inkjet applicator 24 for selectively dispensing the binding agent 36 (FIG. 2C); at least one heat source 32, 32′; a controller 28; and a non-transitory computer readable medium having stored thereon computer executable instructions to cause the controller 28 to: utilize the build material distributor 18 and the inkjet applicator 24 to iteratively form multiple layers 34 (FIG. 28) of build material 16 which are applied by the build material distributor 18 and have received the binding agent 36, thereby creating a patterned 3D printed metal object 42′ (FIG. 2E), and utilize the at least one heat source 32, 32′ to heat 46 the patterned 3D printed metal object 42′ to about a dehydration temperature of the hydrated metal salt thereby affecting binding of the build material particles 16 by creating a 3D printed metal object 42′, continue heating the patterned 3D printed metal object 42′ to the dehydration temperature of the hydrated metal salt, thereby at least partially dehydrating the hydrated metal salt in the 3D printed metal object 42, and heat the 3D printed metal object 42 to a sintering temperature to form a metallic part 50. Sintering can be performed by removing the 3D printed metal object from the printer and transferring the object into e.g. an oven or furnace to heat the 3D printed object to its sintering temperature.

As shown in FIG. 1, the printing system 10 includes a build area platform 12, the build material supply 14 containing build material particles 16, and the build material distributor 18.

The build area platform 12 receives the build material 16 from the build material supply 14. The build area platform 12 may be integrated with the printing system 10 or may be a component that is separately insertable into the printing system 10. For example, the build area platform 12 may be a module that is available separately from the printing system 10. The build area platform 12 that is shown is also one example, and could be replaced with another support member, such as a platen, a fabrication/print bed, a glass plate, or another build surface.

The build area platform 12 may be moved in a direction as denoted by the arrow 20, e.g., along the z-axis, so that build material 16 may be delivered to the platform 12 or to a previously formed layer of build material 16 (see FIG. 2D). In an example, when the build material particles 16 are to be delivered, the build area platform 12 may be programmed to advance (e.g., downward) enough so that the build material distributor 18 can push the build material particles 16 onto the platform 12 to form a layer 34 of the build material 16 thereon (see, e.g., FIGS. 2A and 2B). The build area platform 12 may also be returned to its original position, for example, when a new part is to be built.

The build material supply 14 may be a container, bed, or other surface that is to position the build material particles 16 between the build material distributor 18 and the build area platform 12. In some examples, the build material supply 14 may include a surface upon which the build material particles 16 may be supplied, for instance, from a build material source (not shown) located above the build material supply 14. Examples of the build material source may include a hopper, an auger conveyer, or the like. Additionally, or alternatively, the build material supply 14 may include a mechanism (e.g., a delivery piston) to move the build material particles 16 from a storage location to a position to be spread onto the build area platform 12 or onto a previously formed layer of build material 16.

The build material distributor 18 may be moved in a direction as denoted by the arrow 22, e.g., along the y-axis, over the build material supply 14 and across the build area platform 12 to spread a layer of the build material 16 over the build area platform 12. The build material distributor 18 may also be returned to a position adjacent to the build material supply 14 following the spreading of the build material 16. The build material distributor 18 may be a blade (e.g., a doctor blade), a roller, a combination of a roller and a blade, and/or any other device capable of spreading the build material particles 16 over the build area platform 12. For instance, the build material distributor 18 may be a counter-rotating roller.

The build material 16 may comprise metal particles. The metal may be any metallic material, for example, pure metal or metal alloy. In some examples, the build material may be any particulate metallic material, for example, a powder. The build material 16 may have the ability to sinter into a continuous body to form the metallic part 50 (see, e.g., FIG. 2F) when heated 52 to the sintering temperature (e.g., a temperature ranging from about 950° C. to about 1400° C. for stainless steel powder and from about 800° C. to about 1050° C. for copper). By “continuous body,” it is meant that the metallic build material particles are merged together with the corresponding metal from the metal salt to form a single part with little or no porosity and with sufficient mechanical strength to meet target properties of the final metallic part 50. Although not shown, it will be understood that, once sintered, the object will be of a reduced size as the build material particles are merged together and binder between the particles substantially decomposed/removed.

While an example sintering temperature range is described, it is to be understood that this temperature may vary, depending, in part, upon the composition and phase(s) of the build material 16 and upon the particle size distribution of the metal build material.

As shown in FIG. 1, the printing system 10 also includes an applicator 24, which may contain the binding agent 36 (shown in FIG. 2C) disclosed herein.

The binding agent 36 comprises water and the hydrated metal salt. In some instances, the binding agent 36 consists of water and the hydrated metal salt, without any other components.

The hydrated metal salt may be an intermediate binder in that it is present in various stages of the 3D printed metal object 42, 42′ (shown in FIG. 2E) that is formed, and then decomposes through thermal decomposition. In some examples, only the metal of the hydrated metal salt remains in the final sintered 3D part 50 (shown in FIG. 2F).

The applicator 24 may be scanned across the build area platform 12 in the direction indicated by the arrow 26, e.g., along the y-axis. The applicator 24 may be, for instance, an inkjet applicator, such as a thermal inkjet printhead, a piezoelectric printhead, etc., and may extend a width of the build area platform 12. While the applicator 24 is shown in FIG. 1 as a single applicator, it is to be understood that the applicator 24 may include multiple applicators that span the width of the build area platform 12. Additionally, the applicators 24 may be positioned in multiple print bars. The applicator 24 may also be scanned along the x-axis, for instance, in configurations in which the applicator 24 does not span the width of the build area platform 12 to enable the applicator 24 to deposit the binding agent 36 over a large area of a layer of the build material 16. The applicator 24 may thus be attached to a moving XY stage or a translational carriage (neither of which is shown) that moves the applicator 24 adjacent to the build area platform 12 in order to deposit the binding agent 36 in predetermined areas of a layer of the build material 16 that has been formed on the build area platform 12 in accordance with the method(s) disclosed herein. The applicator 24 may include a plurality of nozzles (not shown) through which the binding agent 36 is to be ejected.

The applicator 24 may deliver drops of the binding agent 36 at a resolution ranging from about 300 dots per inch (DPI) to about 1200 DPI. In other examples, the applicator 24 may deliver drops of the binding agent 36 at a higher or lower resolution. The drop velocity may range from about 2 m/s to about 24 m/s and the firing frequency may range from about 1 kHz to about 100 kHz. In one example, each drop may be in the order of about 10 picoliters (pl) per drop, although it is contemplated that a higher or lower drop size may be used. For example, the drop size may range from about 1 pl to about 400 pl. In some examples, applicator 24 is able to deliver variable size drops of the binding agent 36.

Each of the previously described physical elements may be operatively connected to a controller 28 of the printing system 10. The controller 28 may control the operations of the build area platform 12, the build material supply 14, the build material distributor 18, and the applicator 24. As an example, the controller 28 may control actuators (not shown) to control various operations of the 3D printing system 10 components. The controller 28 may be a computing device, a semiconductor-based microprocessor, a central processing unit (CPU), an application specific integrated circuit (ASIC), and/or another hardware device. Although not shown, the controller 28 may be connected to the 3D printing system 10 components via communication lines.

The controller 28 manipulates and transforms data, which may be represented as physical (electronic) quantities within the printer's registers and memories, in order to control the physical elements to create the 3D part 50. As such, the controller 28 is depicted as being in communication with a data store 30. The data store 30 may include data pertaining to a 3D part 50 to be printed by the 3D printing system 10. The data for the selective delivery of the build material particles 16, the binding agent 36, etc. may be derived from a model of the 3D part 50 to be formed. For instance, the data may include the locations on each layer of build material particles 16 that the applicator 24 is to deposit the binding agent 36. In one example, the controller 28 may use the data to control the applicator 24 to selectively apply the binding agent 36. The data store 30 may also include machine readable instructions (stored on a non-transitory computer readable medium) that are to cause the controller 28 to control the amount of build material particles 16 that is supplied by the build material supply 14, the movement of the build area platform 12, the movement of the build material distributor 18, the movement of the applicator 24, etc.

As shown in FIG. 1, the printing system 10 may also include a heater 32, 32′.

In some examples, patterning may take place in the printing system 10, and then the build material platform 12 with the patterned 3D printed metal object 42′ thereon may be detached from the system 10 and placed into the heater 32 for the various heating stages. In other examples, the heater 32 may be a conductive heater or a radiative heater (e.g., infrared lamps) that is integrated into the system 10. These other types of heaters 32 may be placed below the build area platform 12 (e.g., conductive heating from below the platform 12) or may be placed above the build area platform 12 (e.g., radiative heating of the build material layer surface). Combinations of these types of heating may also be used. These other types of heaters 32 may be used throughout the 3D printing process. In still other examples, the heater 32′ may be a radiative heat source (e.g., a curing lamp) that is positioned to heat each layer 34 (see FIG. 2C) after the binding agent 36 has been applied thereto. In the example shown in FIG. 1, the heater 32′ is attached to the side of the applicator 24, which allows for printing and heating in a single pass. In some examples, both the heater 32 and the heater 32′ may be used.

Referring now to FIGS. 2A through 2F, an example of the 3D printing method is depicted. Prior to execution of printing, the controller 28 may access data stored in the data store 30 pertaining to a 3D part 50 that is to be printed. The controller 28 may determine the number of layers of build material particles 16 that are to be formed, and the locations at which binding agent 36 from the applicator 24 is to be deposited on each of the respective layers.

In FIG. 2A, the build material supply 14 may supply the metallic build material particles 16 into a position so that they are ready to be spread onto the build area platform 12. In FIG. 2B, the build material distributor 18 may spread the supplied build material particles 16 onto the build area platform 12. The controller 28 may execute control build material supply instructions to control the build material supply 14 to appropriately position the build material particles 16, and may execute control spreader instructions to control the build material distributor 18 to spread the supplied build material particles 16 over the build area platform 12 to form a layer 34 of build material particles 16 thereon. As shown in FIG. 2B, one layer 34 of the build material particles 16 has been applied.

The layer 34 has a substantially uniform thickness across the build area platform 12. In an example, the thickness of the layer 34 ranges from about 30 μm to about 300 μm, although thinner or thicker layers may also be used. For example, the thickness of the layer 34 may range from about 20 μm to about 500 μm. The layer thickness may be about 2× the particle diameter (as shown in FIG. 2B) at a minimum for finer part definition. In some examples, the layer thickness may be about 1.2× (i.e., 1.2 times) the particle diameter.

Referring now to FIG. 2C, selectively applying the binding agent 36 on a portion 38 of the build material 16 continues. As illustrated in FIG. 2C, the binding agent 36 may be dispensed from the applicator 24. The applicator 24 may be a thermal inkjet printhead, a piezoelectric printhead, etc., and the selectively applying of the binding agent 36 may be accomplished by the associated inkjet printing technique. As such, the selectively applying of the binding agent 36 may be accomplished by thermal inkjet printing or piezo electric inkjet printing.

The controller 28 may execute instructions to control the applicator 24 (e.g., in the directions indicated by the arrow 26) to deposit the binding agent 36 onto predetermined portion(s) 38 of the build material 16 that are to become part of a patterned 3D printed metal object 42′ and are to ultimately be sintered to form the 3D part 50. The applicator 24 may be programmed to receive commands from the controller 28 and to deposit the binding agent 36 according to a pattern of a cross-section for the layer of the 3D part 50 that is to be formed. As used herein, the cross-section of the layer of the 3D part 50 to be formed refers to the cross-section that is parallel to the surface of the build area platform 12. In the example shown in FIG. 2C, the applicator 24 selectively applies the binding agent 36 on those portion(s) 38 of the layer 34 that are to be fused to become the first layer of the 3D part 50. As an example, if the 3D part that is to be formed is to be shaped like a cube or cylinder, the binding agent 36 will be deposited in a square pattern or a circular pattern (from a top view), respectively, on at least a portion of the layer 34 of the build material particles 16. In the example shown in FIG. 2C, the binding agent 36 is deposited in a square pattern on the portion 38 of the layer 34 and not on the portions 40.

As mentioned above, the binding agent 36 includes the hydrated metal salt and the liquid vehicle (e.g. water). It is to be understood that a single binding agent 36 may be selectively applied to pattern the layer 34, or multiple binding agents 36 may be selectively applied to pattern the layer 34.

While not shown, preparing the binding agent 36 prior to selectively applying the binding agent 36 can be carried out. Preparing the binding agent 36 may include preparing the hydrated metal salt and then adding the hydrated metal salt to water.

When the binding agent 36 is selectively applied in the targeted portion(s) 38, the hydrated metal salt (present in the binding agent 36) infiltrate the inter-particles spaces among the build material particles 16. The volume of the binding agent 36 that is applied per unit of build material 16 in the patterned portion 38 may be sufficient to fill a major fraction, or most of the porosity existing within the thickness of the portion 38 of the layer 34.

It is to be understood that portions 40 of the build material 16 that do not have the binding agent 36 applied thereto also do not have sufficient hydrated metal salt introduced thereto. As such, these portions do not become part of the patterned 3D printed metal object 42′ that is ultimately formed. The portions 40 of build material 16 that do not have the binding agent 36 applied thereto may, nevertheless, come into contact with vapor generated from the binding agent 36 as a result of the heat (see below) applied during the printing process. As the binding agent 36 contains no or little organic solvent, surfactant and/or other organic compounds, the risk of the build material 16 becoming contaminated with such compounds is reduced. Thus, the build material 16 can be readily recycled for printing. The risk of contaminating the 3D printed metal object with organic residue can also be reduced.

Additionally, in some examples, removal of the liquid vehicle from binding agent printed to define 3D metal object 42 may be facilitated by there being little or no organic solvent, surfactant and/or other organic compounds in the binding agent 36. Liquid is removed by evaporation and the evaporation rate of water at a given temperature is considerably higher than that of most organic solvents or surfactants found in traditional 3D printing binding agents (e.g., polyethylene glycol, 2-pyrrolidone, Surfynol 440, Dowfax 2A1). More rapid solvent removal can reduce print cycle time and improves printer productivity.

The processes shown in FIGS. 2A through 2C may be repeated to iteratively build up several patterned layers and to form the patterned 3D printed metal object 42′ (see FIG. 2E).

FIG. 2D illustrates the initial formation of a second layer of build material 16 on the layer 34 patterned with the binding agent 36. In FIG. 2D, following deposition of the binding agent 36 onto predetermined portion(s) 38 of the layer 34 of build material 16, the controller 28 may execute instructions to cause the build area platform 12 to be moved a relatively small distance in the direction denoted by the arrow 20. In other words, the build area platform 12 may be lowered to enable the next layer of build material 16 to be formed. For example, the build material platform 12 may be lowered a distance that is equivalent to the height of the layer 34. In addition, following the lowering of the build area platform 12, the controller 28 may control the build material supply 14 to supply additional build material 16 (e.g., through operation of an elevator, an auger, or the like) and the build material distributor 18 to form another layer of build material particles 16 on top of the previously formed layer 34 with the additional build material 16. The newly formed layer may be patterned with binding agent 36.

Referring back to FIG. 2C, the layer 34 may be exposed to heating using heater 32′ after the binding agent 36 is applied to the layer 34 and before another layer is formed. The heater 32′ may be used for dehydrating the hydrated metal salt in the binding agent 36 during printing layer-by-layer, and for producing a stabilized and 3D printed metal object layer. Heating to form the 3D printed metal object layer may take place at a temperature that is capable of dehydrating the hydrated metal salt in the binding agent 36, but that is not capable of melting or sintering the build material 16. In this example, the processes shown in FIGS. 2A through 2C (including the heating of the layer 34) may be repeated to iteratively build up several layers and to produce the 3D printed metal object 42′. The patterned 3D printed metal object 42′ can then be exposed to the processes described in reference to FIG. 2F.

In some examples, layers of build material 16 and binding agent 36 can be heated layer-by-layer, every two layers, every three layers, or so forth, or once the build material cake 44 has been fully formed to then form the patterned 3D printed metal object 42′.

Repeatedly forming and patterning new layers (with or without curing each layer) results in the formation of a build material cake 44, as shown in FIG. 2E, which includes the patterned 3D printed metal object 42′ residing within the non-patterned portions 40 of each of the layers 34 of build material 16. The patterned 3D printed metal object 42′ is a volume of the build material cake 44 that is filled with the build material 16 and the binding agent 36 within the inter-particle spaces. The remainder of the build material cake 44 is made up of the non-patterned build material 16.

Also as shown in FIG. 2E, the build material cake 44 may be exposed to heat or radiation to generate heat, as denoted by the arrows 46, after the print process has been completed. The heat applied may be sufficient to dehydrate the hydrated metal salt in the binding agent 36 in the patterned 3D printed metal object 42′ and to produce a stabilized and 3D printed metal object 42′. In one example, the heat source 32 may be used to apply the heat to the build material cake 44. In the example shown in FIG. 2E, the build material cake 44 may remain on the build area platform 12 while being heated by the heat source 32. In another example, the build area platform 12, with the build material cake 44 thereon, may be detached from the applicator 24 and placed in the heat source 32. Any of the previously described heat sources 32 and/or 32′ may be used. Heating the build material cake 44 after the printing process has completed may be done to supplement the heating done during the printing process.

The dehydration temperature may depend, in part, on the choice of hydrated metal salt. In some examples, the dehydration temperature may range from about 100° C. to about 250° C.

The length of time at which the heat 46 is applied and the rate at which the patterned 3D printed metal object 42′ is heated may be dependent, for example, on: characteristics of the heat or radiation source 32, 32′, characteristics of the hydrated metal salt, characteristics of the build material 16 (e.g., metal type, particle size, etc.), and/or the characteristics of the 3D part 50 (e.g., wall thickness). The patterned 3D printed metal object 42′ may be heated at the dehydration temperature for a time period ranging from about 1 minute to about 360 minutes. In an example, this time period is about 30 minutes. In another example, this time period may range from about 2 minutes to about 240 minutes. The patterned 3D printed metal object 42′ may be heated to the dehydration temperature at a rate of about 1° C./minute to about 10° C./minute, although it is contemplated that a slower or faster heating rate may be used. The heating rate may depend, in part, on: the binding agent 36 used, the size (i.e., thickness and/or area (across the x-y plane)) of the layer 34 of build material 16, and/or the characteristics of the 3D part 50 (e.g., size, wall thickness, etc.).

Heating to about the dehydration temperature of the hydrated metal salt causes the hydrated metal salt to form a corresponding at least partially dehydrated metal salt. Without wishing to be bound by any theory, the at least partially dehydrated metal salt can, in some examples, coalesce into a continuous dehydrated metal salt phase among the build material particles 16 of the patterned 3D printed metal object 42. The continuous dehydrated metal salt phase may act as an adhesive between the build material particles 16 to form the stabilized 3D printed metal object 42.

In some examples heating the hydrated metal salt may partially decompose the hydrated metal salt to create decomposition products such as metal hydroxides, metal oxides, or metal hydroxynitrides, for example. These decomposition products may also act as an adhesive between build material particles.

Heating to form the patterned 3D printed metal object 42′ may also result in the evaporation of a significant fraction and in some instances all of the water from the patterned 3D printed metal object 42′. Water evaporation may result in some densification, through capillary action, of the 3D printed metal object 42′. Absence of or a reduction in organic compounds or solvents in the binding agent 36 reduces the energy needed to evaporate the liquid component of the binding agent.

The stabilized, 3D printed metal object 42′ exhibits handleable mechanical durability. The 3D printed metal object 42′ may then be extracted from the build material cake 44. The 3D printed metal object 42′ may be extracted by any suitable means. In an example, the 3D printed metal object 42′ may be extracted by lifting the 3D printed metal object 42′ from the unpatterned build material particles 16. An extraction tool including a piston and a spring may be used.

When the 3D printed metal object 42′ is extracted from the build material cake 44, the 3D printed metal object 42′ may be removed from the build area platform 12 and placed in a heating mechanism. The heating mechanism may be the heater 32.

While not being bound to any theory, it is believed that the patterned 3D printed metal object 42′ may maintain its shape due, for example, to: low level necking occurring between the build material particles 16 and the dehydrated metal salt, and/or capillary forces pushing the build material particles 16 together generated by the removal of the water from the binding agent and hydrated metal salt. The 3D printed metal object 42′,42 may maintain its shape even though the build material particles 16 are not yet sintered because of a continuous phase formed by the dehydrated metal salt. Heating may begin the initial stages of sintering, which can result in the formation of weak bonds that are strengthened during final sintering.

In some examples, the 3D printed metal object 42′ may be cleaned to remove unpatterned build material particles 16 from its surface. In an example, the 3D printed metal object 42′ may be cleaned with a brush and/or an air jet.

After the extraction and/or the cleaning of the 3D printed metal object 42′, the 3D printed metal object 42′, 42 may be sintered to form the final 3D part 50, also as shown in FIG. 2F. During heating 52 to sinter using heat source 32, the dehydrated metal salt and some of the corresponding metal oxide can be fully reduced down to the corresponding metal that is then combined with the metal build particles to form the sintered metallic part 50. For avoidance of doubt, the heat source 32 used in sintering may not be part of the printer but e.g. a furnace used as part of the system 10.

Heating to sinter is accomplished at a sintering temperature that is sufficient to sinter the remaining build material particles 16. The sintering temperature is highly depending upon the composition of the build material particles 16. During heating/sintering, the 3D printed metal object 42,42′ may be heated to a temperature ranging from about 80% to about 99.9% of the melting point or the solidus, eutectic, or peritectic temperature of the build material 16. In another example, the 3D printed metal object 42,42′ may be heated to a temperature ranging from about 90% to about 95% of the melting point or the solidus, eutectic, or peritectic temperature of the build material 16. In still another example, the 3D printed metal object 42,42′ may be heated to a temperature ranging from about 70% to about 85% of the melting point or the solidus, eutectic, or peritectic temperature of the build material 16.

The sintering heating temperature may also depend upon the particle size and time for sintering (i.e., high temperature exposure time). As an example, the sintering temperature may range from about 850° C. to about 2500° C. In another example, the sintering temperature is at least 900° C. An example of a sintering temperature for bronze is about 850° C., and an example of a sintering temperature for stainless steel is about 1300° C. While these temperatures are described as sintering temperature examples, it is to be understood that the sintering heating temperature depends upon the build material 16 that is utilized, and may be higher or lower than the described examples. Heating at a suitable temperature sinters and fuses the build material particles 16 to form a completed 3D part 50, which may be even further densified relative to the unsintered 3D printed metal object 42′,42. For example, as a result of sintering, the density may go from 50% density to over 90%, and in some cases very close to 100% of the theoretical density.

The length of time at which the heat 52 for sintering is applied and the rate at which the part 42′ or 42 is heated may be dependent, for example, on: characteristics of the heat or radiation source 32, characteristics of the hydrated metal salt, characteristics of the build material 16 (e.g., metal type, particle size, etc.), and/or the target characteristics of the metallic part 50 (e.g., wall thickness).

In some examples, the heat 52 for sintering is applied in an environment containing an inert gas, a low reactivity gas, a reducing gas, or a combination thereof.

### EXAMPLES

### Comparative Example 1

A binding agent having the composition shown in the Table below was produced:

| Ingredient | % w/w |
|---|---|
| 2-pyrrolidone | 7.5 |
| Alkyldiphenyloxide Disulfonate | 0.5 |
| (Dowfax ™ 2A1 supplied by Dow ® | |
| Chemical) | |
| Non-ionic fluorinated surfactant | 0.025 |
| (Capstone FS-35 supplied by | |
| ChemPoint ®) | |
| Cu(NO₃)₂•3H₂O | 40 |
| H₂O | Balance |

### Example 1

A binding agent having the composition shown in the Table below was produced:

| Ingredient | % w/w |
|---|---|
| Cu(NO₃)₂•3H₂O | 40 |
| H₂O | Balance |

### Example 2

The binding agents of Comparative Example 1 and Example 1 were tested for their jetting performance.

The binding agent of Example 1 was shown to maintain drop consistency and nozzle health during the jetting process well past 100 million drops per nozzle. The jetting performance of the binding agent of Example 1 was also evaluated on a Dalmata® 3D printing test bed. The binding agent of Example 1 was as effective as the binding agent of Comparative Example 1. In other words, the binding agent of Example 1 was found to maintain the same drop consistency and nozzle health during jetting.

### Example 3

In this Example, a copper strip was printed using the binding agent of Example 1 and copper powder as build material. The 3D printing process employed was similar to that described above in relation to FIGS. 1 and 2 above. Even prior to sintering, the printed copper strip was robust and determined to have a fracture strength in the range of 3-4 MPa.

### Example 4

3D printing was performed using copper build material and the binding agent of Comparative Example 1 above. After a predetermined number of cycles, the recycled build material was analyzed by heating the powder in air at 130° C. The build material was analyzed by visual inspection and by thermogravimetric analysis (TGA). The process was repeated using the binding agent of Example 1 and the results compared.

The build material used in combination with the binding agent of Comparative Example 1 was green, while the build material used in combination with the binding agent of Example 1 was blue. The TGA analysis showed that the build material used in combination with the binding agent of Comparative Example 1 has a higher level of organic residue compared to the build material used in combination with the binding agent of Example 1.

### Definitions

Unless otherwise stated, any feature described hereinabove can be combined with any example or any other feature described herein.

In describing and claiming the examples disclosed herein, the singular forms “a,” “an,” and “the” include plural referents unless the context clearly dictates otherwise.

As used herein, the terms “hydrated metal salt,” “metal salt,” “hydrated salt,” or “salt” are used interchangeably generally or specifically to refer to a metal salt that is hydrated.

As used herein, “(s)” at the end of some terms indicates that those terms/phrases may be singular in some examples or plural in some examples. It is to be understood that the terms without “(s)” may be also be used singularly or plurally in many examples.

It is to be understood that concentrations, amounts, and other numerical data may be expressed or presented herein in range formats. It is to be understood that such range formats are used merely for convenience and brevity and thus should be interpreted flexibly to include not just the numerical values explicitly recited as the end points of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same applies to ranges reciting a single numerical value.

Reference throughout the specification to “one example,” “some examples,” “another example,” “an example,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

Unless otherwise stated, references herein to “wt %” of a component are to the weight of that component as a percentage of the whole composition comprising that component. For example, references herein to “wt %” of, for example, a solid material such as polyurethane(s) or colorant(s) dispersed in a liquid composition are to the weight percentage of those solids in the composition, and not to the amount of that solid as a percentage of the total non-volatile solids of the composition.

If a standard test is mentioned herein, unless otherwise stated, the version of the test to be referred to is the most recent at the time of filing this patent application.

All amounts disclosed herein and in the examples below are in wt % unless indicated otherwise.

1. A kit for 3D printing a 3D printed metal object, said kit comprising
build material comprising metal particles; and
a binding agent comprising
a hydrated metal salt having a dehydration temperature of from 100 to about 250° C., and
water;
wherein:
the binding agent is free from organic solvent and surfactant, or
the binding agent comprises organic solvent and/or surfactant and the total amount of organic solvent and/or surfactant is less than 3 weight % based on the total weight of the binding agent.

2. The kit of claim 1, wherein binding agent is free from organic compounds, or the binding agent comprises organic compounds in an amount of less than 3 weight % based on the total weight of the binding agent.

3. The kit of claim 1, wherein the binding agent comprises organic solvent in an amount of less than 1 weight % based on the total weight of the binding agent.

4. The kit of claim 1, wherein the binding agent comprises surfactant in an amount of less than 0.5 weight % based on the total weight of the binding agent.

5. The kit of claim 1, wherein the binding agent comprises organic solvent and/or surfactant and the total amount of organic solvent and/or surfactant is less than 1 weight % based on the total weight of the binding agent.

6. The kit of claim 1, wherein the binding agent consists essentially of hydrated metal salt and water.

7. The kit of claim 1, wherein the amount of hydrated metal salt in the binding agent is about 20 to about 65 weight % based on the total weight of the binding agent.

8. The kit of claim 1, wherein a metal present in the build material is the same as a metal present in the hydrated metal salt.

9. The kit of claim 1, wherein the hydrated metal salt in the binding agent comprises a metal cation selected from at least one of aluminium, magnesium, copper, zinc, iron, nickel, manganese, cobalt, molybdenum, chromium, tin and vanadium, and an anion selected from at least one of hydroxide, carbonate, sulphate, nitrate, acetate, formate, borate, chloride and bromide.

10. The kit of claim 1, wherein the hydrated metal salt in the binding agent is hydrated copper nitrate.

11. The kit of claim 10, wherein the binding agent comprises 35 to 58 weight % hydrated copper nitrate and 42 to 65 weight % water.

12. The kit of claim 1, wherein the build material comprises copper,

13. A method of 3D printing a 3D printed metal object, said method comprising:
selectively applying a binding agent onto build material comprising metal particles, wherein the binding agent comprises:
a hydrated metal salt having a dehydration temperature of from 100 to about 250° C., and
water;
wherein:
the binding agent is free from organic solvent and surfactant, or
the binding agent comprises organic solvent and/or surfactant and the total amount of organic solvent and/or surfactant is less than 3 weight % based on the total weight of the binding agent.
and
heating the build material and selectively applied binding agent to bind a layer of the 3D printed metal object.

14. The method of claim 13, which comprises:
(i) applying a layer of build material to a previously bound layer of the 3D printed object,
(ii) selectively applying binding agent to the layer of build material, and
(iii) heating the layer of build material to bind a further layer of the 3D printed metal object,
wherein steps (i) to (iii) are repeated in sequence a plurality of times.

15. The method of claim 14, which further comprises sintering bound layers of the 3D printed metal object to form a sintered 3D printed metal object.
